(19) United States
(12) Patent Application Publication
(10) Pub. No.: US 2024/0123710 A1
(43) Pub. Date: Apr. 18, 2024

(54) LAMINATED GLAZING

(71) Applicant: AGC GLASS EUROPE, Louvain-la-Neuve (BE)

(72) Inventor: Tokihiko AOKI, Gosselies (BE)

(73) Assignee: AGC GLASS EUROPE, Louvain-la-Neuve (BE)

(21) Appl. No.: 18/546,829

(22) PCT Filed: Feb. 21, 2022
(86) PCT No.: PCT/EP2022/054221

§ 371 Date: Aug. 17, 2023

(30) Foreign Application Priority Data
Feb. 25, 2021 (EP) 21159427.0

(51) Int. Cl. B32B 17/10; B32B 7/02

(52) U.S. Cl. CPC B32B 17/10761; B32B 7/02; B32B 17/10036; B32B 17/10899; B32B 2307/7376; B32B 2419/00; B32B 2605/00

(57) ABSTRACT

A laminated glazing, and an associated method and use, including a first and a second glass panels laminated together by an interlayer assembly. The interlayer assembly includes a multi-layered acoustic thermoplastic interlayer. The interlayer assembly further includes a thermoplastic layer with low acoustic performances and placed between the multi-layered acoustic thermoplastic interlayer and the first or the second glass panel. The light transmission of the multi-layered acoustic thermoplastic interlayer (TLc) equals to, or is higher, than 50% of the light transmission of the thermoplastic layer (TLd).

### TECHNICAL FIELD

The present application relates to laminated glazing especially acoustic laminated glazing. Such laminated glazing are generally used for vehicles or buildings to reduce disturbance by external noise.

### BACKGROUND ART

Nowadays, privacy and acoustic comfort is important inside a building or a vehicles.

Privacy can be obtained with curtains in front of the glazing. Using tinted glass and/or reflective coatings can increase the privacy in front of the glazing.

To increase the acoustic comfort by reducing disturbance by external noise, several technics exist.

A first technic is to install a multiple glazing having two glass panels separated by a gap filled by gas and were the two or more glass panels have different thickness to absorb different frequencies. Such multiple glazings are mainly used to increase thermal isolation but are thick and not secured.

Another technic is to install laminated glazing meaning two or more glass panels separated by at least one plastic interlayer. Classical interlayers have no acoustic performances that is why a special interlayer, namely acoustic interlayer, developed for their acoustic performance, having a high damping coefficient, is used to further improve the soundproofing to reduce disturbance by external noise. Unfortunately, these interlayers are often expensive, or have poor mechanical properties required for their conditions of use. For example, the mechanical properties are insufficient for safety windows for buildings or for motor-vehicle windows.

These monolayer acoustic interlayers have a glass transition temperature (Tg) between 0 and 10 degree C. and are too soft to handle in room temperature.

It is known from EP0763420B1 an acoustic laminated glazing having an monolayer acoustic interlayer and a second interlayer, a standard interlayer having poor acoustic performances, to improve the handling of such monolayer acoustic interlayer and to improve the safety of the laminated glazing.

Such acoustic interlayer contains, in addition to the base polymer or polymers, plasticizers giving it high damping or low stiffness properties. The acoustic interlayer and the standard interlayer are separated by a thin (50 μm) PET film, a chemical separation, made of a material intended to ensure chemical separation of the two other interlayers. This chemical separation is used to avoid migration of plasticizer.

Acoustic interlayers are expensive to produce and to buy. Then, when the laminated glazing is used for privacy and acoustic comfort, depending of the wanted privacy level, several tinted glass and/or several tinted acoustic interlayers are stored. It means that a lot of money is blocked due to stocks.

On top of that, ecology and environment protection become more and more important. Interlayers can be made of recycled material to reduce the carbon footprint and reduce the cost. But this recycled material is made with a mix of used interlayers and/or interlayer scraps from different suppliers. The main problem with such recycled material is the lack of chemical stability due to different origins. Due to their poor chemical stability, migration of plasticizers is increased reducing acoustic performances. Thus, acoustic interlayer are not made of recycled material.

### SUMMARY OF INVENTION

The present invention relates, in a first aspect, to a laminated glazing comprising a first and a second glass panels laminated together by an interlayer assembly. The interlayer assembly comprises a multi-layered acoustic thermoplastic interlayer.

The solution as defined in the first aspect of the present invention is based on that the interlayer assembly further comprises a thermoplastic layer with low acoustic performances and placed between the multi-layered acoustic thermoplastic interlayer and the first or the second glass panel.

The solution is also based on that the light transmission of the multi-layered acoustic thermoplastic interlayer (TLc) equals to or higher than 50% of the light transmission of the thermoplastic layer (TLd), preferably the light transmission of the multi-layered acoustic thermoplastic interlayer (TLc) equals to or higher than 60% of the light transmission of the thermoplastic layer (TLd), more preferably the light transmission of the multi-layered acoustic thermoplastic interlayer (TLc) equals to or higher than 65% of the light transmission of the thermoplastic layer (TLd).

Surprisingly, the thermoplastic layer permits to give a privacy inside the building or the vehicle while the presence of the multi-layered acoustic thermoplastic interlayer and the thermoplastic layer reduces the migration of plasticizer and keeps acoustic performances of the laminated glazing.

Surprisingly, the thermoplastic layer absorbs the mismatch of the shape between the first and the second glass panels even if the thickness of the interlayer assembly is higher because of the presence of the thermoplastic layer.

The present invention relates, in a second aspect, to the use of a thermoplastic layer in a laminated assembly according to the first aspect to absorb the mismatch of the shape between the first and the second glass panels while color matching the laminated assembly with a glazing assembly placed next to the laminated assembly.

It is noted that the invention relates to all possible combinations of features recited in the claims or in the described embodiments.

The following description relates to automotive applications but it's understood that the invention may be applicable to others fields like building or transportation applications.

### BRIEF DESCRIPTION OF THE DRAWINGS

This and other aspects of the present invention will now be described in more detail, with reference to the appended drawings showing various exemplifying embodiments of the invention which are provided by way of illustration and not of limitation. The drawings are a schematic representation and not true to scale. The drawings do not restrict the invention in any way. More advantages will be explained with examples.

FIG. 1 is a schematic view of an embodiment of a laminated glazing according to the invention.

### DETAILED DESCRIPTION

It is an object of the present invention to alleviate the above described problems and to solve the need for privacy and acoustic comfort.

Another advantage of the present invention is to provide a laminated glazing with an interlayer assembly able to absorb the mismatch of the shape between the first and the second glass panels.

Another advantage of the present invention is to match a specific color with very limit stocks especially when the laminated glazing is placed beside another glazing that can be made with another assembly and/or composition. Thus, the present invention is able to color match the laminated assembly with a glazing assembly placed next to it with limited stocks and increasing liquidity.

In the following description, unless otherwise specified, expression “substantially” mean to within 10%, preferably to within 5%.

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second and the like as the term soft in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

According to a first aspect of the invention, the invention relates to a laminated glazing 10 comprising a first 1 and a second 2 glass panels laminated together by an interlayer assembly 3.

The laminated glazing can be used to close an opening of the stationary object, such as a building, or to close an opening of the mobile object, such a train, a boat, . . . .

Usually, the material of the glass panels is, for example, soda-lime silica glass, borosilicate glass, aluminosilicate glass or other materials such as thermoplastic polymers or polycarbonates which are especially known for automotive applications. References to glass throughout this application should not be regarded as limiting.

The laminated glazing can have any shape to fit to the opening such as a rectangular shape, in a plan view by using a known cutting method. As a method of cutting the laminated glazing, for example, a method in which laser light is irradiated on the surface of the laminated glazing to cut it, or a method in which a cutter wheel is mechanically cutting can be used. The laminated glazing can have any shape in order to fit with the application, for example a windshield, a sidelite, a sunroof of an automotive, a lateral glazing of a train, a window of a building, . . . .

Glass panels can be manufactured by a known manufacturing method such as a float method, a fusion method, a redraw method, a press molding method, or a pulling method. As a manufacturing method of the multi-glazed window, from the viewpoint of productivity and cost, it is preferable to use the float method.

Each panel can be independently processed and/or colored, . . . and/or have different thickness in order to improve the aesthetic, thermal insulation performances, safety, . . . . The thickness of the multi-glazed window 2 is set according to requirements of applications.

Each glass panel can be processed, i.e. annealed, tempered, to respect the specifications of security requirements. The transparent dielectric panel can independently be a clear or a colored transparent dielectric panel, tinted with a specific composition or by applying an additional coating or a plastic layer for example.

Each glass panel can be independently processed and/or colored, . . . and/or have different thickness in order to improve the aesthetic, safety, . . . .

Preferably, to reduce the storage cost, glass panels have the same composition and preferably the light transmission of the first glass panel (TLg1) and the light transmission of the second glass panel (TLg2) equals to or is higher than 50%, preferably equals to or is higher than 60% and more preferably equals to or is higher than 70%.

In some embodiments, the light transmission of the laminated glazing (TLIg) equals to or is lower than 25%, preferably equals to or is lower than 22%, more equals to or is lower than 20% and even more preferably equals to or is lower than 17%.

The shape of the multi-glazed window in a plan view is usually a rectangle. Depending of the application, the shape is not limited to a rectangle and may be a trapeze, especially for a windshield or a backlite of a vehicle, a triangle, especially for a sidelight of a vehicle, a circle or the like.

In addition, the multi-glazed window can be assembled within a frame or be mounted in a double skin façade, in a carbody or any other means able to maintain a multi-glazed window. Some plastics elements can be fixed on the multi-glazed window to ensure the tightness to gas and/or liquid, to ensure the fixation of the multi-glazed window or to add external element to the multi-glazed window. In some embodiments, a masking element, such as an enamel layer, can be added on part of the periphery of the multi-glazed window.

For thermal comfort inside the stationary object or mobile object, a coating system can be present on one interface of the multi-glazed window. This coating system generally uses a metal-based layer and infrared light is highly refracted by this type of layer. Such coating system is typically used to achieve a low-energy multi-glazed window.

In some embodiment, the coating system can be a heatable coating applied on the multi-glazed window to add a defrosting and/or a demisting function for example and/or to reduce the accumulation of heat in the interior of a building or vehicle or to keep the heat inside during cold periods for example. Although coating system are thin and mainly transparent to eyes.

Usually, the coating system is covering most of the surface of the interface of the multi-glazed window 2.

The coating system can be made of layers of different materials. In some embodiments, for example in automotive windshields, the coating system can be electrically conductive over the majority of one major surface of the multi-glazed window. This can causes issues such as heated point if the portion to be decoated is not well designed.

A suitable coating system is for example, a conductive film. A suitable conductive film, is for example, a laminated film obtained by sequentially laminating a transparent dielectric, a metal film, and a transparent dielectric, ITO, fluorine-added tin oxide (FTO), or the like. A suitable metal film can be, for example, a film containing as a main component at least one selected from the group consisting of Ag, Au, Cu, and Al.

Typically, the coating system has an emissivity of not more than 0.4, preferably equals to or less than 0.2, in particular equals to or less than 0.1, equals to or less than 0.05 or even equals to or less than 0.04.

The coating system may comprise a metal based low emissive coating system. Such coating systems typically are a system of thin layers comprising one or more, for example two, three or four, functional layers based on an infrared radiation reflecting material and at least two dielectric coatings, wherein each functional layer is surrounded by dielectric coatings. The coating system of the present invention may in particular have an emissivity of at least 0.010. The functional layers are generally layers of silver with a thickness of some nanometers, mostly about 5 to 20 nm. The dielectric layers are generally transparent and made from one or more layers of metal oxides and/or nitrides. These different layers are deposited, for example, by means of vacuum deposition techniques such as magnetic field-assisted cathodic sputtering, more commonly referred to as “magnetron sputtering”. In addition to the dielectric layers, each functional layer may be protected by barrier layers or improved by deposition on a wetting layer.

In some embodiments, to maximize the transmission and the reception through the glazing panel having a coating system, a decoated portion can be used to reduce attenuation due to the coating system.

According to the invention, the interlayer assembly 3 comprises a multi-layered acoustic thermoplastic interlayer 31 and a thermoplastic layer 32 placed between the multi-layered acoustic thermoplastic interlayer and the first or the second glass panel. The thermoplastic layer has low acoustic performances.

The term acoustic means that the thermoplastic interlayer has superior damping function. This damping function is characterized by having loss factor larger than 0.2 in the first resonance point when measured by ISO/PAS 16940.

The term multi-layered means that the multi-layered acoustic thermoplastic interlayer is made of several layers 311, 312, 313.

Preferably, the multi-layered acoustic thermoplastic interlayer comprises a first thermoplastic interlayer 311, a second thermoplastic interlayer 312 and a soft thermoplastic interlayer 313; the soft thermoplastic interlayer being sandwiched between the first and the second thermoplastic interlayer.

According to the invention, to have good acoustic performances of the laminated glazing, the shear modulus of the soft thermoplastic interlayer 313 is smaller by substantially at least 50% than the shear modulus of the first 311 and the second 312 thermoplastic interlayer at 20 deg Celsius. Preferably, the shear modulus of the soft thermoplastic interlayer 313 is smaller by substantially two times the shear modulus of the first 311 and the second 312 thermoplastic interlayer at 20 deg Celsius, more preferably, the shear modulus of the soft thermoplastic interlayer 313 is smaller by substantially five times the shear modulus of the first 311 and the second 312 thermoplastic interlayer at 20 deg Celsius and even more preferably the shear modulus of the soft thermoplastic interlayer 313 is smaller by substantially ten times the shear modulus of the first 311 and the second 312 thermoplastic interlayer at 20 deg Celsius In preferred embodiments, the shear modulus of the first 311 and the second 312 thermoplastic interlayer are substantially the same.

Preferably, the composition of the acoustic thermoplastic, the first and the second interlayers comprises polyvinyl butyral (PVB), ethylene-vinyl acetate (EVA), polymethyl methacrylate (PMMA), a polycarbonate (PC), a polystyrene (PS), a polyvinyl chloride (PVC), a polyamide (PA), a polyetherimide (PEI), a polyethylene terephthalate (PET), a polyurethane (PU), an acrylonitrile butadiene styrene copolymer (ABS), a styrene acrylonitrile copolymer (SAN), a styrene methyl methacrylate copolymer (SM MA) and any mixtures of these, a crosslinked resin, an ionoplast, an ionomer and preferably comprises PVB, EVA or PU. More preferably, for compatibility and to reduce cost, the composition of the acoustic thermoplastic, the first and the second interlayers comprises polyvinyl butyral.

The composition of the multi-layered acoustic thermoplastic interlayer further comprises plasticizer.

Preferably, to optimize the process of manufacture while keeping high performances, the composition of the first 311 and the second 312 thermoplastic interlayer is the same.

In some preferred embodiments, the composition of the thermoplastic layer comprises polyvinyl butyral (PVB), ethylene-vinyl acetate (EVA), polymethyl methacrylate (PMMA), a polycarbonate (PC), a polystyrene (PS), a polyvinyl chloride (PVC), a polyamide (PA), a polyetherimide (PEI), a polyethylene terephthalate (PET), a polyurethane (PU), an acrylonitrile butadiene styrene copolymer (ABS), a styrene acrylonitrile copolymer (SAN), a styrene methyl methacrylate copolymer (SMMA) and any mixtures of these, a crosslinked resin, an ionoplast, an ionomer and preferably comprises PVB, EVA or PU.

In preferred embodiments, the composition of the thermoplastic layer comprises PVB

In some embodiments, the thermoplastic layer comprises recycled materials comprising at least two or more chemical compositions, to reduce cost while keeping the acoustic performances of the laminated glazing.

Recycled materials with two or more compositions means there are different chemistries in terms of basic interlayer resin, type and amount of plasticizer or adhesion control ions mixed into one product. This could happen when glass processors cut out the excess of interlayer from glass peripherals in lamination process, collect them from different interlayer product or producers and recycled interlayer producer uses this excess as a raw material without making any sorting.

Normally standard PVB interlayer is made by an extrusion process. This classical process comprises following steps:
1) mixing and melting PVB resin, plasticizer and other minor chemical components such as adhesion control ions or ultra-violet ray blockers,
2) extruding the melted material to a sheet,
3) cooling down the extruded sheet,
4) sorting out the edge of the sheet in order to collect on the center area where the thickness is homogeneous and
5) winding the sheet to a roll.

Cut-out sheet in process step 4) is used as a recycled material and mixed into the process 1). These operations are done in a single and unique PVB manufacturer. Therefore, the chemical composition of the PVB remains always the same.

However, in this invention, referred recycle material is coming out from glass lamination process in glass manufactures which often utilizes different PVB composition from several PVB manufactures. Therefore, the composition of recycled PVB is more diverse and unstable than the mentioned standard PVB used in the classical process because it could contain different type of PVB resins, plasticizers, adhesion control ions and/or UV absorbers.

According to the invention, composition of recycled PVB used in the present invention could contain different level of PVB resin molecular weight from 200,000 to 400,00. This can be measured by GPC (Gel Permeation Chromatography).

According to the invention, composition of recycled PVB used in the present invention could also contain two or more types of adhesion control ions. Ions can be made of magnesium (Mg), sodium (Na), Potassium (K), sulfur (S), phosphorus (P), rhodium (Rh) or palladium (Pd). Presence of these ions are detectable by XRF (fluorescent X-ray analysis).

According to the invention, recycled PVB sheet made of different type of PVB resin or adhesion control ions could also have a higher reactivity to mentioned soft thermoplastic interlayer resulting in degradation such as decomposition of PVB resin or plasticizer migration from the soft layer to adjacent layer. Therefore, separating recycled PVB layer and soft thermoplastic layer, namely made of PVB is quite important.

Preferably, to ensure acoustic performances while having a good privacy, the thermoplastic layer is placed between the multi-layered acoustic thermoplastic interlayer and the second glass panel.

According to the invention, the light transmission of the multi-layered acoustic thermoplastic interlayer (TLc) defined by illuminant A 2 degree equals to or is higher than 50% of the light transmission of the thermoplastic layer (TLd), preferably the light transmission of the multi-layered acoustic thermoplastic interlayer (TLc) equals to or is higher than 60% of the light transmission of the thermoplastic layer (TLd), more preferably the light transmission of the multi-layered acoustic thermoplastic interlayer (TLc) equals to or is higher than 65% of the light transmission of the thermoplastic layer (TLd). These measures of light transmission are performed by laminating two clear glass sheets of 3 mm thick glass with the multi-layered acoustic thermoplastic interlayer.

The term clear used for glass means a light transmission more than substantially 88% for a 2 mm thick glass.

The term clear for interlayer means a light transmission of more than substantially 85%. for the interlayer laminated with two sheets of said clear glass.

Preferably, the light transmission of the thermoplastic layer (TLd) equals to or is lower than 80% of the light transmission of the multi-layered acoustic thermoplastic interlayer (TLc), preferably the light transmission of the thermoplastic layer (TLd) equals to or is lower than 75% of the light transmission of the multi-layered acoustic thermoplastic interlayer (TLc). These measures of light transmission are performed by laminating two clear glass sheets of 3 mm thick glass with the thermoplastic layer.

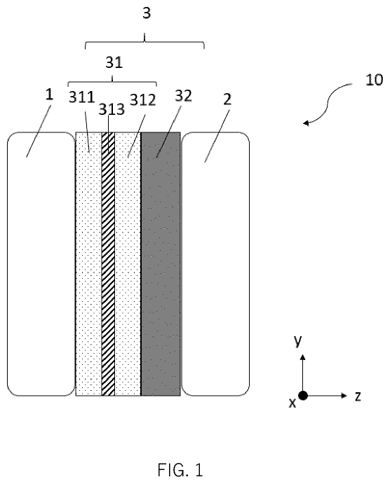

According to FIG. 1, thicknesses are measured in Z-axis while X- and Y-axis defined a plane. Preferably surfaces of the first glass panel and the second glass panel are substantially parallel to plane defined by X- and Y-axis.

According to the invention, the thicknesses of the first and the second glass panels equal to or are lower than 2.1 mm, preferably equal to or are lower than 1.9 mm, more preferably equal to or are lower than 1.7 mm, even more preferably equal to or are lower than 1.6 mm.

In some embodiments, the thicknesses of the first and the second glass panels equal to or are higher than 0.1 mm, preferably equal to or are higher than 0.3 mm, more preferably equal to or are higher than 0.5 mm, even more preferably equal to or are higher than 0.7 mm

According to the invention, the thickness of the multi-layered acoustic thermoplastic interlayer equals to or is lower than 0.85 mm, preferably equals to or is lower than 0.6 mm and more preferably equals to or is lower than 0.55 mm.

In some embodiments, the thickness of the multi-layered acoustic thermoplastic interlayer equals to or is higher than 0.40 mm, preferably equals to or is higher than 0.45 mm and more preferably equals to or is higher than 0.50 mm.

According to the invention, to optimize the acoustic performances, the thermoplastic layer is thinner than the multi-layered acoustic thermoplastic interlayer.

Preferably, the thickness of the thermoplastic layer equals to or is lower than 0.5 mm, preferably equals to or is lower than 0.4 mm and more preferably equals to or is lower than 0.38 mm allowing to absorb tolerances and mismatch between surfaces of the first and the second glass panels.

Preferably, the thickness of the thermoplastic layer equals to or is higher than 0.3 mm, preferably equals to or is higher than 0.35 mm.

In some embodiments to keep acoustic performances, the sum of the thickness of the multi-layered acoustic thermoplastic interlayer and the thickness of the thermoplastic layer is higher than or equals to 0.85 mm.

In some preferred embodiments to have a good privacy, the laminated glazing has a transmission color defined by illuminant D65 incident angle 10 deg.:

45≤L*≤55

−3.0≤a*≤1.0

−1.0≤b*≤3.0

and light transmission of the laminated glazing (TLg) defined by illuminant A with incident angle 10 deg. is comprises between 15% and 25% (15%≤TLg≤25%).

In some preferred embodiments to reduce cost, storage and handling, the first and the second glass panels are clear glass panels.

In some preferred embodiments to reduce cost, storage and handling, the multi-layered acoustic thermoplastic interlayer is a clear multi-layered acoustic thermoplastic interlayer.

The term clear means that the light transmission of the object such as a glass panel or/and an interlayer is higher than or equals to 85% and preferably is higher than or equals to 90% and more preferably is higher than or equals to 95%.

According to a preferred embodiment, the thickness of the first glass panel is 1.6 mm and the thickness of the second glass panel is 1.6 mm, the thickness of multi-layered acoustic thermoplastic interlayer is 0.5 mm and the thickness of the thermoplastic layer is 0.38 mm. The first and the second glass panels are soda lime glass panels. The first and the second thermoplastic interlayer of the multi-layered acoustic thermoplastic interlayer are PVB and the soft thermoplastic interlayer is a PVB and has Shear modulus smaller by substantially 50% than the shear modulus of the first 311 and the second 312 thermoplastic PVB interlayer at 20 deg Celsius. The thermoplastic layer is a recycled PVB. It is understood that different PVB grade can be used in such preferred embodiments.

The present invention provides a method to produce a laminated glazing according to the first aspect. The method comprise a step of assembling interlayers of the multi-layered acoustic thermoplastic interlayer together before a step of placing the multi-layered acoustic thermoplastic interlayer with the thermoplastic layer between the first and the second glass panels.

The present invention furthers comprises a method of colour matching a laminated assembly according to the first aspect of the invention with a glazing assembly that can be placed beside it. The method comprises following steps:
A. Calculating the a* and b* of the glazing assembly
B. Selecting the thermoplastic layer to have the laminated assembly with a* b* substantially equals to the calculating a* b* in step A.
C. Assembling the selected thermoplastic layer with a multi-layered acoustic thermoplastic interlayer between the first and the second glass panels

The present invention provides in a second aspect the use of a thermoplastic layer in a laminated assembly according to the first aspect of the invention to absorb the mismatch of the shape between the first and the second glass panels while color matching the laminated assembly with a glazing assembly placed next to the laminated assembly

1: A laminated glazing comprising a first glass panel and a second glass panel laminated together by an interlayer assembly the interlayer assembly further comprises
a multi-layered acoustic thermoplastic interlayer,
a thermoplastic layer with low acoustic performances placed between the multi-layered acoustic thermoplastic interlayer and the first glass panel or the second glass panel, and
wherein a light transmission of the multi-layered acoustic thermoplastic interlayer (TLc) equals to or is higher than 50% of the light transmission of the thermoplastic layer with low acoustic performance (TLd) (TLc≥0.5 TLd).

2: The laminated glazing according to claim wherein the light transmission of the thermoplastic layer (TLd) equals to or is lower than 80% of the light transmission of the multi-layered acoustic thermoplastic interlayer (TLc) (TLd≤0.8 TLc).

3: The laminated glazing according to claim 1, wherein the multi-layered acoustic thermoplastic interlayer comprises a soft thermoplastic interlayer, a first thermoplastic interlayer and a second thermoplastic interlayer; the soft thermoplastic interlayer being sandwiched between the first thermoplastic interlayer and the second thermoplastic interlayer.

4: The laminated glazing according to claim 1, wherein the thermoplastic layer is a polyvinyl butyral.

5: The laminated glazing according to claim 1, wherein the thermoplastic layer comprises a recycled material.

6: The laminated glazing according to claim 1, wherein a thickness of the first glass panel and a thickness of the second glass panel are equal to or are lower than 2.1 mm.

7: The laminated glazing according to claim 1, wherein a thickness of the multi-layered acoustic thermoplastic interlayer equals to or is lower than 0.8 mm.

8: The laminated glazing according to claim 1, wherein the thermoplastic layer is thinner than the multi-layered acoustic thermoplastic interlayer.

9: The laminated glazing according to claim 1, wherein a thickness of the thermoplastic layer equals to or is lower than 0.5 mm.

10: The laminated glazing according to claim 1, wherein a sum of a thickness of the multi-layered acoustic thermoplastic interlayer and a thickness of the thermoplastic layer is higher than or equals to 0.85 mm.

11: The laminated glazing according to claim 1, wherein the thermoplastic layer has a following transmission colour defined by illuminant D65 with an incident angle of 10 deg.:
45≤L*≤55,
−3.0≤a*≤1.0, and
−1.0≤b*≤3.0.

12: A method of producing a laminated glazing according to claim 1, comprising:
assembling layers of the interlayer assembly together, and
placing the interlayer assembly between the first glass panel and the second glass panel.

13: A method colour matching a laminated glazing according to claim 1 with a glazing assembly, comprising:
calculating an a* and a b* of the glazing assembly,
selecting the thermoplastic layer to have the laminated assembly with a* and b* being substantially equal to the calculating of a* and b*, and
assembling the selected thermoplastic layer with a multi-layered acoustic thermoplastic interlayer between the first glass panel and the second glass panel.

14: A method for installing a thermoplastic layer in a laminated glazing according to claim 1, comprising:
absorbing a mismatch of a shape between the first glass panel and the second glass panel, and
colour matching the laminated assembly with a glazing assembly placed next to the laminated assembly.

15: The laminated glazing according to claim 1, wherein the light transmission of the multi-layered acoustic thermoplastic interlayer (TLc) equals to or is higher than 60% of the light transmission of the thermoplastic layer (TLd) (TLc≥0.6 TLd).

16: The laminated glazing according to claim 1, wherein the light transmission of the multi-layered acoustic thermoplastic interlayer (TLc) equals to or is higher than 65% of the light transmission of the thermoplastic layer (TLd) (TLc≥0.65 TLd).

17: The laminated glazing according to claim 1, wherein the light transmission of the thermoplastic layer (TLd) equals to or is lower than 75% of the light transmission of the multi-layered acoustic thermoplastic interlayer (TLc) (TLd≤0.75 TLc).

18: The laminated glazing according to claim 1, wherein a thickness of the first glass panel and a thickness of the second glass panel are equal to or are lower than 1.9 mm.

19: The laminated glazing according to claim 1, wherein a thickness of the multi-layered acoustic thermoplastic interlayer equals to or is lower than 0.6 mm.

20: The laminated glazing according to claim 1, wherein a thickness of the thermoplastic layer equals to or is lower than 0.4 mm.
